(19) United States
(12) Patent Application Publication
(10) Pub. No.: US 2024/0287646 A1
(43) Pub. Date: Aug. 29, 2024

(54) A RECYCLING METHOD FOR BATTERY AND CATALYST MATERIALS

(71) Applicant: GELION TECHNOLOGIES PTY LTD, North Sydney, NSW (AU)

(72) Inventors: Benjamin EADE, Sonning Common (GB); Daniel MARIN FLORIDO, Sonning Common (GB); Paul Noel O'SHAUGHNESSY, Sonning Common (GB); Claudia BINDER, Sonning Common (GB); Julia VALLEJO NAVARRET, Sonning Common (GB)

(21) Appl. No.: 18/567,524

(22) PCT Filed: Apr. 12, 2022
(86) PCT No.: PCT/GB2022/050912

§ 371 Date: Dec. 6, 2023

(30) Foreign Application Priority Data
Jun. 11, 2021 (GB) 2108372.0

(51) Int. Cl. C22B 3/00; C22B 3/32; C22B 7/00; C22B 15/00; C22B 26/12; C22B 47/00; H01M 10/54

(52) U.S. Cl. CPC C22B 23/0415; C22B 3/32; C22B 7/007; C22B 15/0067; C22B 23/0461; C22B 23/0484; C22B 26/12; C22B 47/00; H01M 10/54

(57) ABSTRACT

A method of recycling Ni and/or Co from a functional material such as a battery or catalyst material, the method comprising: forming an acidic aqueous recycling feed of the functional material by acid leaching the functional material or a derivative thereof, the acidic aqueous recycling feed comprising Ni and/or Co in solution; contacting the acidic aqueous recycling feed with an organic solvent extraction composition; and extracting one or both of Ni and Co from the acidic aqueous recycling feed into the organic solvent extraction composition, wherein the organic solvent extraction composition comprises: an organic solvent which is immiscible with the acidic aqueous recycling feed; a picolinic acid ester or picolinic acid amide which is soluble in the organic solvent; and a phase transfer catalyst.

### FIELD

The present invention relates to a method of recycling Ni and/or Co from functional materials comprising Ni and/or Co. Such functional materials include battery materials and in particular battery cathode materials. Such functional materials also include catalyst materials, e.g. Fischer-Tropsch catalyst materials. These functional materials comprise Ni and/or Co and optionally Mn and/or Li. For example, certain lithium ion battery cathode materials comprise all of Ni, Co, Mn, and Li. In this case, the present invention can be used as part of a system to separate and purify all four of these elements from spent or scrap lithium ion battery cathode material for re-use, for example, in manufacturing new lithium ion battery cathode materials.

### BACKGROUND

Lithium ion batteries are now ubiquitous in modern society, finding use not only in small, portable devices such as mobile phones and laptop computers but also increasingly in electric vehicles.

A lithium ion battery generally includes a graphite anode separated from a cathode by an electrolyte, through which lithium ions flow during charging and discharging cycles. The cathode in a lithium ion battery may include a lithium transition metal oxide, for example a lithium nickel oxide, lithium cobalt oxide or lithium manganese oxide.

Although lithium ion and other modern rechargeable batteries offer a promising low-carbon energy source for the future, one concern is that the metals required for their manufacture, such as lithium, nickel, cobalt and/or manganese, often command high prices due to their limited availability and difficulty of extraction from natural sources. There is therefore a need for methods which recycle or purify the metals present within batteries, such as the metals present within the cathodes of batteries, to provide materials which may be used as feedstock in battery manufacture.

Solvent extraction (also known as liquid-liquid extraction, LLE) is one method which has been used to extract, separate and purify metal elements present in solutions obtained from battery recycling processes (herein referred to as effluent solutions). Solvent extraction involves contacting an aqueous phase, containing the metals to be extracted, with an organic phase containing a solvent extractant. After extraction, the phase containing the metals of interest is known as the “extract” and the phase containing the residual impurities is known as the “raffinate”.

During battery material recycling processes, an effluent solution is generated containing valuable metal elements such as cobalt and nickel which could be used in the manufacture of new battery materials if they could be extracted in sufficient purity. Such solutions may be generated by leaching from waste battery materials including so-called “black mass”, a mixture of valuable metals alongside unwanted impurities. Such solutions therefore include other less desirable or unwanted metal elements or impurities. The solutions may contain a mixture of metal elements and it is often desirable to extract only one, or a limited number, of these metal elements.

Di-(2-ethylhexyl) phosphoric acid (D2EHPA) is one compound which has been used previously as a solvent extractant in such processes. This compound is known to complex cobalt at pH 4 and nickel at pH 5. However, D2EHPA also complexes manganese at pH 3. As a result, when the effluent solution contains a mixture of Co, Ni and Mn, all three of these are extracted to some extent by D2EHPA, such that the extract contains a mixture of at least three metals and possibly more. It is therefore difficult to obtain, for example, a pure extract of Co and Ni without also extracting other metals such as Mn. This makes subsequent processing and further separation difficult and limits the applications of the extract.

It is often necessary to perform multiple separate extraction steps, using different solvent extractants, in order to selectively extract metals from solutions. This is a costly and complex procedure and it would be desirable to provide an extractant capable of extracting one, or a small number, of metals selectively or preferentially from a solution in a single extraction step.

There is therefore a need for alternative processes for extracting metal elements such as Co and Ni from battery recycling effluent via solvent extraction, and alternative solvent extractant compositions which facilitate this. It would be particularly desirable to be able to simultaneously and preferentially extract Ni and Co.

In addition to the need to recycle Co and Ni from battery materials, these elements are also increasingly been used in catalyst materials for industrial chemical processes. Such catalysts include Fischer-Tropsch catalyst materials. As such, a similar need exists for recycling of Co and Ni from such catalysts in addition to battery materials recycling.

### SUMMARY OF THE INVENTION

Back in 1981, U.S. Pat. No. 4,254,087 proposed a method for processing mining ore to extract copper, nickel or cobalt from the mining ore. The mining ore was treated with an acid to produce an acidic aqueous ore leach liquor comprising metal species in solution. This acidic aqueous ore leach liquor was then subjected to a liquid-liquid extraction process using an extractant system comprising an organic solvent, a high molecular weight alkylaromatic sulfonic acid, and a chelating amine. It was indicated that such a system is useful for the selective extraction of desired metals, e.g., cobalt, nickel or copper ions, from aqueous acidic mining ore leach liquors.

A large number of possible chelating amines were disclosed in U.S. Pat. No. 4,254,087 for processing mining ore including various picolylamines, oxazoles, benzoxazoles, pyridyl imidazoles, and picolinic acid esters and amides.

The present inventors have now surprisingly found that picolinic acid esters and amides, preferably picolinamides, are particularly well suited for recycling lithium ion battery cathode waste material. As previously indicated, typical lithium ion battery cathode materials comprise Ni, Co, Mn, and Li. Waste material from such batteries in the form of so-called “black-mass” comprise all of these elements in addition to other metallic elements, carbon, etc. It has been found that picolinic acid esters and amides can be used as chelating agents in a liquid-liquid extraction process, in combination with a phase transfer catalyst or so-called “synergist”, to selectively extract Ni and/or Co from such lithium ion battery waste materials as part of a battery recycling process. Furthermore, having demonstrated this technique for recycling of lithium ion battery waste materials, it is also proposed to use the same technique for recycling of Ni and/or Co from industrial catalyst waste materials comprising Ni and/or Co.

Accordingly, the present specification provides a method of recycling Ni and/or Co from a functional material comprising Ni and/or Co, the method comprising:
forming an acidic aqueous recycling feed of the functional material by acid leaching the functional material or a derivative thereof, the acidic aqueous recycling feed comprising Ni and/or Co in solution;
contacting the acidic aqueous recycling feed with an organic solvent extraction composition; and
extracting one or both of Ni and Co from the acidic aqueous recycling feed into the organic solvent extraction composition,
wherein the organic solvent extraction composition comprises:
(a) an organic solvent which is immiscible with the acidic aqueous recycling feed;
(b) a picolinic acid ester or picolinic acid amide which is soluble in the organic solvent; and
(c) a phase transfer catalyst.

A functional material is one which is used in a commercial product, e.g. an electrical device, or a commercial process, e.g. an industrial chemical production process. The function material may be a battery material, optionally a battery cathode material such as a lithium ion battery cathode material. In this case, battery waste material is a derivative of the original functional battery material and will typically be in the form of so-called “black-mass” which is subjected to the initial acid leaching step in the process defined above. Alternatively, the functional material may be a catalyst material, optionally a Fischer-Tropsch catalyst material. Such materials are in ever increasing demand and there is an ever increasing need to be able to recycle such functional materials for re-use. It has been found that picolinic acid esters and amides, particularly the picolinamides, are very effective in selectively extracting Co and/or Ni from scrap/waste of such functional materials for re-use.

The functional material may comprise both Ni and Co as is the case, for example, in many lithium ion battery cathode materials and Fischer-Tropsch catalysts. In this case, both the Ni and Co are dissolved in the acidic aqueous recycling feed and both Ni and Co are co-extracted into the organic solvent extraction composition. It has been found that using the organic extraction compositions of the present invention it is possible to co-extract Ni and Co into the organic extraction composition and then selectively strip the Ni and Co from the organic solvent extraction composition to produce two separate aqueous solutions, one comprising Ni and one comprising Co. A “clean” Ni containing solution can be obtained by selective stripping. In contrast, the Co containing solution may comprise a small quantity of Ni impurity. However, this is not problematic for battery and cathode recycling processes as these functional materials typically comprise much more Ni than Co. As such, when the Co is re-used to fabricate new functional materials comprising Ni and Co, the small amount of Ni impurity in the Co is not problematic.

It has been found that the Ni and Co can be selectively stripped from the organic solvent extraction compositions by using aqueous acid solutions of different strengths. A weak acid can be used to extract the Co followed by a strong acid to extract the Ni. As such, the selective stripping comprises: (i) contacting the organic solvent extraction composition with a first acidic solution to extract Co from the organic solvent extraction composition; and then (ii) contacting the organic solvent extraction composition with a second acidic solution to extract Ni from the organic solvent extraction composition, the second acidic solution having a lower pH than the first acidic solution. The acid used for the selective stripping can be sulfuric, hydrochloric, or nitric acid. For certain applications such as battery materials recycling, sulfuric acid is preferred. Acid concentration are from 0.01M to 5M, depending on the metal to be stripped. For example, Co can be stripped using H₂SO₄ at a concentration in a range 0.01 to 0.1 M whereas Ni can be stripped using H₂SO₄ at a concentration in a range 1 to 5 M. As such, the selective stripping can be achieved by changing the concentration of sulfuric acid. A cobalt stream is achieved by contacting the loaded organic with 0.01 to 0.1 M H₂SO₄ in one or two stages depending of the concentration in the loaded organic. This stream may also have between 0 to 20% nickel content. A clean nickel stream is achieved by contacting the loaded organic after the cobalt stream with 1 to 5 M H₂SO₄ in one or two consecutive stages.

The functional material may further comprise Mn. For example, typical lithium ion battery cathode materials comprise Mn in addition to Ni and Co. In this case, the Mn can be dissolved in the acidic aqueous recycling feed along with the Ni and/or Co. However, the Mn is not extracted into the organic extraction composition. Rather, the Mn is either removed from acidic aqueous recycling feed prior to contacting with the organic solvent extraction composition or the Mn remains in the acidic aqueous recycling feed when the Ni and/or Co are extracted from the acidic aqueous recycling feed into the organic solvent extraction composition. If the organic solvent extraction composition is then subjected to selective stripping of Ni and Co as previously described, a three-way separation of Ni, Co, and Mn can be achieved.

The functional material may further comprise Li. Again, lithium ion battery cathode materials comprise Li in addition to Ni, Co and Mn. In this case, the Li can be extracted from the functional material or a derivative thereof prior to extracting the Ni and/or Co. For example, the Li can be extracted (e.g. from black-mass) by dissolution in an organic acid, optionally formic acid, in which Li is soluble while Ni, Co, and Mn are insoluble. This step can be performed prior to acid leaching of the Ni, Co, and Mn from the black mass to form the acidic aqueous recycling feed comprising the Ni, Co, and Mn.

It should further be noted that depending on the composition of the functional material, or waste material derivative thereof, one or more intermediate treatment steps may be performed between the steps of forming the acidic aqueous recycling feed and contacting the acidic aqueous recycling feed with the organic extraction composition to extract Ni and Co. For example, if Cu and/or Fe are present in the material to be recycled, which is the case for battery waste, then these components will also be present in the acidic aqueous recycling feed and must be extracted prior to contacting with the organic solvent extraction composition as these elements are strongly extracted by the picolinic acid ester/amide compositions described herein. Cu and/or Fe can be extracted from the acidic aqueous recycling feed using known methods prior to performing the Ni/Co extraction step.

The picolinic acid ester or picolinic acid amide may be defined by the following formula:

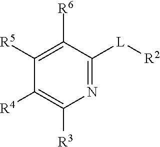

or a salt, solvate or hydrate thereof, wherein:
L is selected from —C(═O)N(R^{1A})—* and —C(═O)O—*, wherein R^{1A} is selected from hydrogen and unsubstituted straight or branched chain C₁₋₁₂ alkyl and the asterisk (*) indicates the point of attachment to R²;
R² is selected from straight or branched chain C₄₋₂₀ aliphatic groups; and
either (i) one or two of R³, R⁴, R⁵ and R⁶ are independently selected from hydrogen and methyl, and the remaining groups of R³, R⁴, R⁵ and R⁶ are hydrogen; or (ii) the groups R³ and R⁴ and the atoms to which they are attached form an unsubstituted 6-membered aryl or an unsubstituted 6-membered heteroaryl, and each of R⁵ and R⁶ are independently selected from hydrogen and methyl.

The picolinic acid ester or picolinic acid amide may be defined by the above formula, wherein one or more of the following criteria are met:
wherein L is —C(═O)N(R^{1A})—*;
wherein R^{1A} is hydrogen;
wherein R² is selected from straight or branched chain C₆₋₁₀ alkyl groups, optionally substituted with one or two groups R^{2A};
wherein R² is selected from straight chain unsubstituted C₆₋₁₀ alkyl groups;
wherein R² is unsubstituted n-octyl; and
wherein each of R³, R⁴, R⁵ and R⁶ are hydrogen.

The phase transfer catalyst (PTC) may also be referred to as a synergist. A PTC or synergist is a reagent that enables or enhances the reaction between two or more reagents, when the reaction is inhibited due to the lack of interaction between the reactants. Specifically, for solvent extraction and in this system, a PTC or synergist is a molecule capable of enabling and/or enhancing transfer of the metals from the aqueous phase into the organic phase. In the present system, without the synergist the metal transfer does not occur. For the present system, several requirements need to be fulfilled by the PTC or synergist:
soluble in the dilutant suitable for solvent extraction (such as long chain hydrocarbons, long chain alcohols or aromatics);
insoluble in aqueous (acidic, basic or neutral) solutions;
being an anion or being capable of deprotonating to form an anion at pHs relevant to metal extraction; and
the negative charge on the PTC/synergist at the pH of extraction should be between 1 and 3, preferably 1 or 2, most preferably 1.

The phase transfer catalyst may be a phosphoric acid or a sulfonic acid. For example, the phase transfer catalyst may be defined by the following formula:

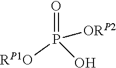

or a salt, solvate or hydrate thereof, wherein:
R^{P1} is independently selected from hydrogen and (hetero)hydrocarbyl groups; and
R^{P2} is independently selected from (hetero)hydrocarbyl groups, or
the phase transfer catalyst may be defined by the formula:

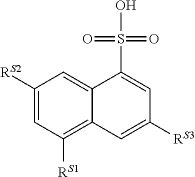

where R^{S1} is a sulfonic group (SO₃H) or a hydrogen (H), and R^{S2} and R^{S3} are either both alkyl chains or one is an alkyl chain and the other is a hydrogen.

In the case of the phase transfer catalyst being the phosphoric acid defined above, R^{P1} and R^{P2} may each be independently selected from straight or branched chain unsubstituted C₄₋₁₂ alkyl groups.

In the case of the phase transfer catalyst being the sulfonic acid defined above, R^{S1} may be H, and R^{S2} and R^{S3} may be both CH₂(CH₂)₇CH₃.

The reaction involving the metal species, chelating ligand, and synergist (phase transfer catalyst) is shown below:

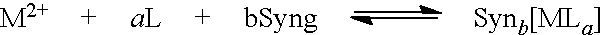

where M is a divalent transition metal (Co or Ni), L is the ester or amide of picolinic acid, Syn is the synergist, a is 1, 2 or 3 depending on M, and b is defined as 2/n to provide charge neutrality in the resulting organic soluble complex where n is the charge on the deprotonated synergist at the pH of extraction.

Advantageously, the molar ratio of Syn:L is in a range 1:1 to 1:5, most preferably 1:1.5 to 1:2. While increasing the amount of synergist can increase extraction it can also lead to a loss of selectivity in the presence of impurities. Accordingly, if an excess of synergist is used, loss of selectivity occurs when impurities are present (e.g. Al is extracted by an excess of synergist).

Several preferred conditions/features for the present recycling system are summarized below:
pKa of the amide: 1 to 5, preferably around 2 (picolinamide is 2.2).
pKa of synergist: 0 to 5, preferably 0 to 1 (the synergist is required to be more acidic than picolinamide, so the value to have good extraction and stripping needs to be lower than the pKa of the amide).
pH of extraction: 0.5 to 4, preferably 1 to 3, and more preferably 2 to 2.5 for Ni; optionally 3 for Co.
Stripping: 0.01 to 0.1 M sulfuric acid for Co; 1 to 5 M sulfuric acid for Ni.

The organic solvent is selected to be insoluble with the acidic aqueous recycling feed while functioning to dissolve the picolinic acid ester or picolinic acid amide. For example, the organic solvent may comprise or consist of a hydrogenated petroleum distillate composition comprising C₈₋₁₆ hydrocarbons and/or be selected from one or more or an aromatic hydrocarbon, a straight chain aliphatic hydrocarbon, a branched chain aliphatic hydrocarbon, and an alcohol, preferably a branched chain alcohol, most preferably a C₈-C₁₃ branched alcohol.

### DESCRIPTION OF THE DRAWINGS

FIG. 1 shows an example of a battery materials recycling process;

FIG. 2 shows another example of a battery materials recycling process;

FIG. 3 shows a number of examples of picolinamide compounds;

FIG. 4 shows a graph illustrating % extraction of Ni versus pH; and

FIG. 5 shows a graph illustrating % extraction of versus pH for extraction of a mixed metal sulfate feed.

### DETAILED DESCRIPTION

As described in the summary section, the present specification provides a method of recycling Ni and/or Co from a functional material comprising Ni and/or Co, the method comprising:
forming an acidic aqueous recycling feed of the functional material by acid leaching the functional material or a derivative thereof, the acidic aqueous recycling feed comprising Ni and/or Co in solution;
contacting the acidic aqueous recycling feed with an organic solvent extraction composition; and
extracting one or both of Ni and Co from the acidic aqueous recycling feed into the organic solvent extraction composition,
wherein the organic solvent extraction composition comprises:
(a) an organic solvent which is immiscible with the acidic aqueous recycling feed;
(b) a picolinic acid ester or picolinic acid amide which is soluble in the organic solvent; and
(c) a phase transfer catalyst or synergist.

Preferably the method comprises co-extraction of both Ni and Co into the organic solvent extraction composition and then selectively stripping the Ni and Co using acids of different strength to produce an aqueous solution of Ni and an aqueous solution of Co.

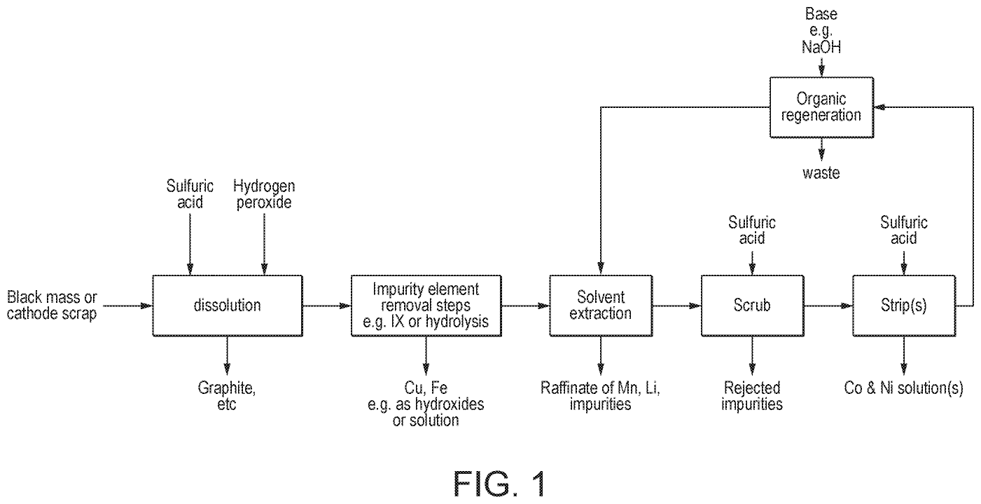

While the method may be applied to recycling of a range of functional materials which comprise Ni and/or Co, it is particularly useful for lithium ion battery cathode material recycling. In this regard, FIG. 1 shows an example of a battery materials recycling process. The starting material is cathode scrap or so-called “black-mass” which typically comprises Li, Ni, Co, Mn and impurities including Cu and Fe. The material is subjected to an acid dissolution or leaching step to obtain an acidic aqueous recycling feed comprising the constituent metal species in solution. Impurities such as Cu and Fe can be removed by ion exchange or hydrolysis. An organic solvent extraction step can then be applied to separate Co and Ni (in the organic phase) from Mn and Li. An acid scrub can further be applied to the organic phase to remove any impurities prior to stripping of the Co and Ni into aqueous Co and Ni solutions. The organic phase can be regenerated and recycled for use in further extraction of Co and Ni.

The method of FIG. 1 enables Co and Ni to be separated from the cathode black mass material. However, further process steps are required if separation of Li and Mn from each other is to be achieved.

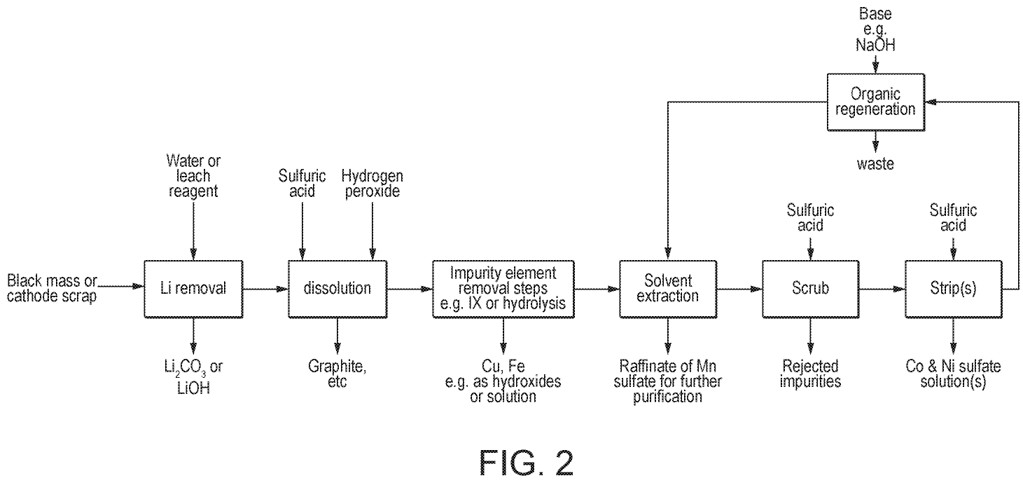

FIG. 2 shows another example of a battery materials recycling process. Again, the starting material is cathode scrap or so-called “black-mass” which typically comprises Li, Ni, Co, Mn and impurities including Cu and Fe. However, in this example, the lithium is removed first by treatment with a suitable solvent (e.g. an organic acid such as formic acid) which dissolves Li but not the other metal species. The remaining material is subjected to an acid dissolution or leaching step to obtain an acidic aqueous recycling feed comprising the remaining constituent metal species in solution. Impurities such as Cu and Fe can be removed by ion exchange or hydrolysis. An organic solvent extraction step can then be applied to separate Co and Ni (in the organic phase) from Mn. An acid scrub can further be applied to the organic phase to remove any impurities prior to stripping of the Co and Ni into aqueous Co and Ni solutions. The organic phase can be regenerated and recycled for use in further extraction of Co and Ni.

The method of FIG. 2 is advantageous in that it enables an efficient 4-way separation of Li, Mn, Co, and Ni to be achieved.

In accordance with the present specification, the organic solvent extraction composition for performing the Co and Ni extraction advantageously comprises a picolinic acid ester or picolinic acid amide and a phase transfer catalyst or synergist and the Co and Ni are advantageously selectively stripped from the organic solvent extraction composition as described in the summary section.

### Synthesis of Picolinamide Compounds

Synthesis of picolinamide compounds was achieved by two different methods shown in Scheme 1 and Scheme 2 respectively.

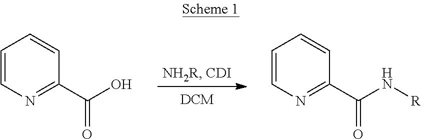

In the general synthesis shown in Scheme 1, picolinic acid 1 is reacted with primary amine 2 in the presence of 1,1′-carbonyldiimidazole (CDI) and dichloromethane (DCM) or tetrahydrofuran (THF) to form the picolinamide product 3. The reaction is performed by heating under reflux. The reaction mixture is washed first with water, then with brine, followed by drying with anhydrous Na₂SO₄. Residual solvent is removed under vacuum to give the pure product 3.

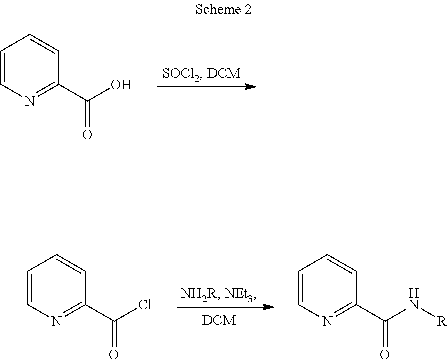

In the general synthesis shown in Scheme 2, picolinic acid 1 is reacted with SOCl₂ in the presence of dichloromethane (DCM) to form the intermediate acyl chloride 4. The intermediate 4 is then reacted with primary amine 2 in the presence of triethylamine (NEt₃) and dichloromethane (DCM) to form the picolinamide product 3.

A more specific example of a compound synthesis is set out below for the following molecule:

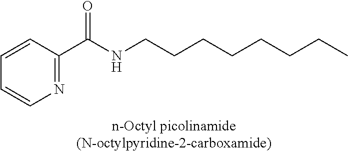 [SMILES: CCCCCCCCNC(=O)c1ccccn1]

5.5 g (33 mmol) of CDI and 2.7 g (22 mmol) of picolinic acid were weighed out in a 100 ml round-bottom flask. To this, 50 mL of THF was added. An initial effervescence was observed. Once both reagents were completely dissolved, 3.6 mL (22 mmol) of n-octylamine was charged into the reactor. The mixture was heated under reflux overnight and then allowed to cool. The mixture was then washed with water (3×60 mL), washed with brine (3×60 mL) and finally washed with saturated NaHCO₃ (3×60 mL). During the aqueous washing purification steps, it was noted that the product is partially water-soluble, which suggests it may be effective as a solvent extractant which could complex a metal within an aqueous phase and extract it into the organic phase. The organic phase was then dried with anhydrous Na₂SO₄ and the residual solvent was removed under vacuum. The resultant material was further purified by silica gel chromatography using hexane:ethyl acetate as eluent, giving the product compound as a pale yellow liquid, with a yield of greater than 95%. The product was analysed by ¹H NMR spectroscopy to confirm its identity.

A further example of a compound synthesis is set out below for the following molecule:

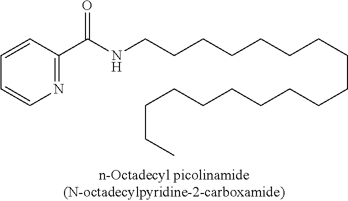 [SMILES: CCCCCCCCCCCCCCCCCCNC(=O)c1ccccn1]

5.5 g (33 mmol) of CDI and 2.7 g (22 mmol) of picolinic acid were weighed out in a 100 ml round-bottom flask. To this, 50 mL of THF was added. An initial effervescence was observed. Once both reagents were completely dissolved, 5.9 g (22 mmol) of n-octadecylamine was charged into the reactor. The mixture was heated under reflux overnight and then allowed to cool. The mixture was then washed with water (3×60 mL), washed with brine (3×60 mL) and finally washed with saturated NaHCO₃ (3×60 mL). The organic phase was then dried with anhydrous Na₂SO₄ and the residual solvent was removed under vacuum, giving the product compound as a pale orange solid.

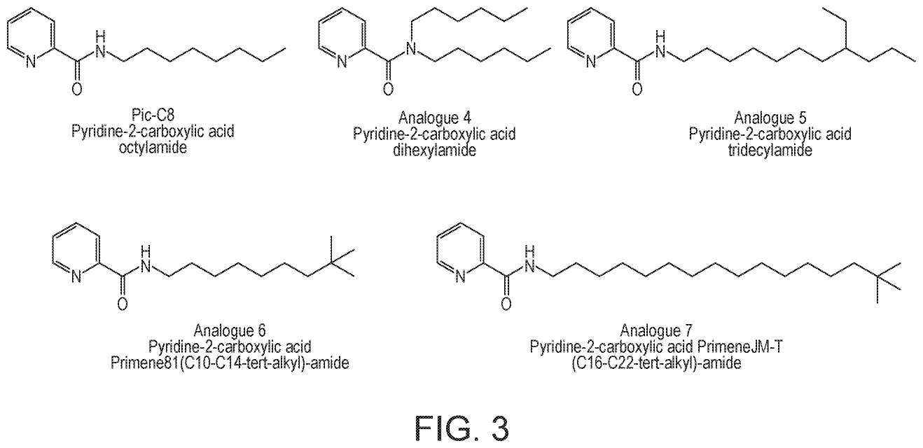

FIG. 3 shows a number of examples of picolinamide compounds used in the extraction and stripping experiments summarized below to illustrate and exemplify the present invention.

### Co-Extraction and Selective Stripping Examples

In the examples, reagent grade metal sulfate salts and water were used to prepare aqueous synthetic leach solutions, containing one or more of the following metals: nickel, cobalt, manganese, lithium, magnesium, iron, copper, aluminium and zinc with a total metal concentration of 4 to 70 grams/litre. The ratio of elements was based on different battery cathode materials (see examples for details). The pH of the stock solution was adjusted with sulfuric acid or sodium hydroxide to reach a pH in the range of 1 to 3. A known volume of the organic phase, comprising the picolinamide extractant, phase transfer catalyst and inert diluent, was then added to the aqueous leach solution to obtain an organic: aqueous volume ratio of 1:1. The reaction mixture was then vigorously stirred until the equilibrium pH was attained. If a pH adjustment was required, either concentrated sulfuric acid solution or saturated sodium hydroxide solution (or lithium hydroxide) was then added until the required pH was attained, and the mixture vigorously stirred again until the equilibrium pH was attained. The two phases were then carefully separated. The organic phase was stripped with either nitric acid, hydrochloric acid or sulfuric acid in the range of 0.01 to 5 M. A second stripping may be performed if required. The concentration of the metal ions in the resulting aqueous solution (raffinate) was determined by Inductively Coupled Plasma-Optical Emission Spectroscopy (ICP-OES), which was then used to determine the metal ion concentration in the organic phase (difference in concentration between the feed and the aqueous raffinate).

### Example 1—Pic C₈ (Picolinamide Extractant Shown in FIG. 3)/D2EHPA (Phase Transfer Catalyst or Synergist)/Ni Feed

50 mL of 0.125 M Pic-C₈ and 0.083 M D2EHPA organic solution in a polar aliphatic diluent system of EXXAL 13: 1-octanol in a 3:2 volume ratio was contacted with 50 mL of 2.38 g/L nickel sulfate solution at an organic to aqueous volume ratio of 1:1. 800 μL of 5 M lithium hydroxide solution was added to adjust the aqueous equilibrium pH to 5.33. Separation and analysis of the aqueous phase showed that 0.09 g/L Ni remained in the raffinate (96% extraction with a Ni distribution coefficient of 25). The loaded organic was then contacted with 1 M sulfuric acid at an organic to aqueous volume ratio of 1:1. ICP-OES analysis showed that 100% stripping was achieved in a single contact with a distribution coefficient of 0.01, producing a 2.28 g/L Ni strip liquor.

### Example 2—Pic C₈/DNNDSA (Dinonylnaphthalenedisulfonic Acid)/Ni Feed—Effect of pH

15 mL of 0.14 M Pic-C₈ and 0.093 M DNNDSA organic solution in EXXAL 13:1-octanol in a 3:2 volume ratio was contacted with 15 mL of 2.0 g/L nickel sulfate solution at an organic to aqueous volume of 1:1. The pH of the solutions was adjusted using concentrated NaOH solution and each step was allowed to reach equilibrium contacting for 20 min. ICP analysis of the aqueous phase gave the following results:

### Results in Ppm of the Extraction Experiment Using Pic-C₈ and DNNDSA as a PTC

| | V_{NaOH} added | | % |
|---|---|---|---|
| pH | (mL) | Ni (ppm) | extraction |
| feed | | 2005.5 | |
| 0 | 0.85 | 1458 | 34 |
| 0.5 | 0.5 | 1188.6 | 57 |
| 1 | 1.1 | 876.9 | 78 |
| 1.4 | 1.34 | 763.0 | 86 |
| 1.7 | 1.4 | 721.1 | 89 |
| 2 | 1.69 | 670.8 | 92 |

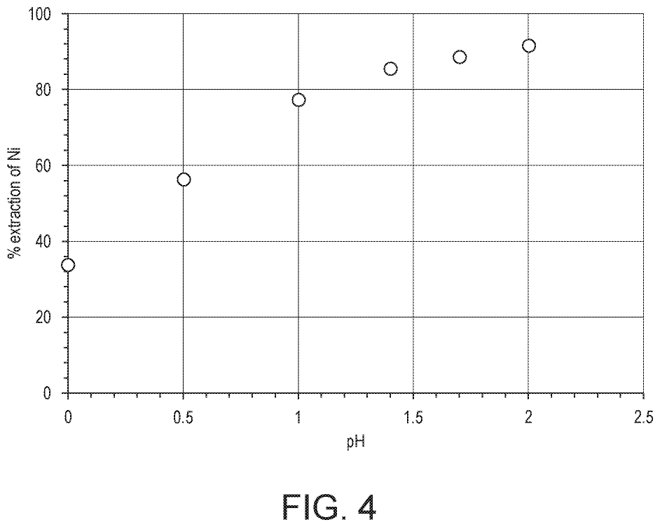

FIG. 4 shows a graph of the results illustrating % extraction of Ni versus pH. From the results is clear that more than 90% nickel uptake is achieved in one stage contact at pH 2.

### Example 3—Pic C₈/DNNSA (Dinonylnaphthalenesulfonic Acid)/Ni Feed—Effect of Different Diluents

50 mL of 0.0625 M Pic-C₈ and 0.042 M DNNSA organic solution in different diluents (xylene, ethyl caprylate and EXXAL 13:1-octanol) was contacted with 50 ml of 1.2 g/L nickel sulfate solution. The pH of the mixture was adjusted, using concentrated NaOH, to pH 2.5 and stirred until reaching equilibrium. Separation and ICP analysis of the phases show that different diluents have an effect in the extraction of nickel, EXXAL 13: 1-octanol being the best mixture for one contact stage. The loaded organic was then contacted with 1M H₂SO₄ at an organic to aqueous volume ratio of 1:1. ICP-OES analysis showed that 83% stripping was achieved in a single contact for EXXAL 13:1-octanol proving to be the best overall diluent for this system taking into account both extraction and stripping performance. Results are indicated in the table below.

### ICP Analysis of the Organic and Aqueous Phase for Extraction

| | | | Distribution | |
|---|---|---|---|---|
| | Raffinate | Organic | coefficient | % |
| Diluent | [Ni] (g/L) | [Ni] (g/L) | Ni | Extraction |
| xylene | 1.19 | 1.18 | 0.99 | 99 |
| ethyl caprylate | 1.17 | 1.2 | 1.03 | 103 |
| EXXAL 13:octanol | 1.22 | 1.11 | 0.91 | 91 |
| (3:2) | | | | |

### ICP Analysis of the Organic and Aqueous Phase for Stripping of the Organic Loaded

| | | | Distribution | |
|---|---|---|---|---|
| | Strip liquor | Organic | coefficient | % |
| Diluent | [Ni] (g/L) | [Ni] (g/L) | Ni | Stripping |
| xylene | 0.45 | 0.73 | 1.59 | 39 |
| ethyl caprylate | 0.58 | 0.62 | 1.07 | 48 |
| EXXAL 13:octanol | 0.96 | 0.18 | 0.19 | 83 |
| (3:2) | | | | |

### Example 4—Pic C₈/DNNSA—Mixed Metal Feed

80 mL of a 0.125 M Pic-C₈ and 0.083 M DNNSA organic solution (the DNNSA was pre-cleaned with a 4 M HCl+NaCl acid contact) in a polar aliphatic diluent system of EXXAL 13: 1-octanol in a 3:2 volume ratio was contacted with 50 mL of a mixed metal sulfate feed at an organic to aqueous volume ratio of 1:1. The metal concentrations in the feed are shown in the table below and reflect a Ni to Mn to Co ratio of 6:6:2 with impurity metals at 10% of the Ni molarity.

### Metal Concentrations in the Aqueous Feed in Ppm

| | Li | Ni | Mn | Co | Al | Mg | Zn |
|---|---|---|---|---|---|---|---|
| Feed conc (ppm) | 590 | 2040 | 170 | 620 | 90 | 50 | 210 |

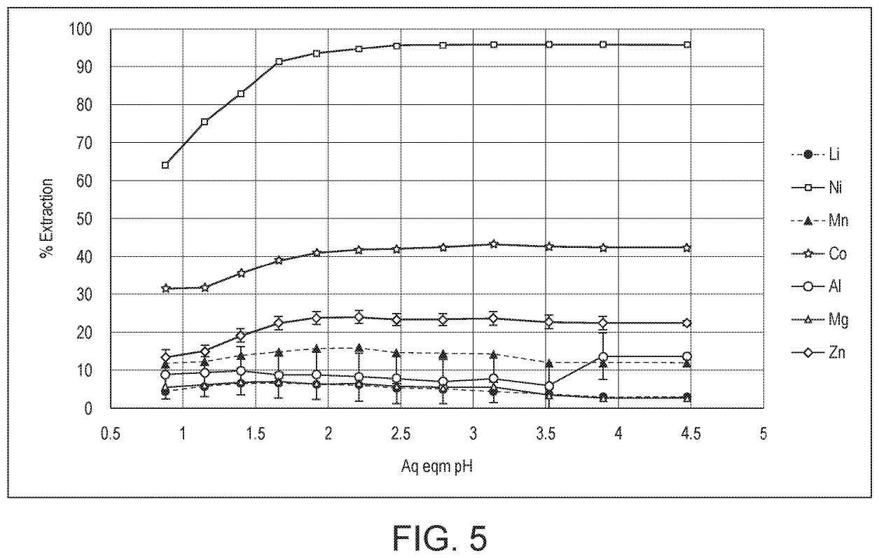

The total moles of the target metals for extraction—nickel and cobalt—equals a third of the Pic-C₈ moles, as these metals form a 3:1 ligand to metal ratio complex. The pH was adjusted by approximately 0.3 pH units at a time by adding saturated sodium hydroxide solution, and aqueous samples were taken at each pH. Separation and aqueous ICP-OES analysis produced the pH extraction curves shown in FIG. 5 which illustrates a graph of % extraction against aqueous equilibrium pH for extraction of the mixed metal sulfate feed into an organic phase of 0.125 M Pic-C₈ and 0.083 M DNNSA in EXXAL 13:1-octanol 3:2 at an organic to aqueous ratio of 1:1. This shows that at an extraction pH of 2.5, 95% Ni extraction is achieved, with 40% Co and 25% Zn co-extraction, and minimal co-extraction of the other metals present—Li, Mn, Al, Mg. In a counter-current system with multiple (e.g. three) stages, complete extraction of Ni, Co, and Zn should be achieved.

The loaded organic was then contacted with 0.1 M sulfuric acid solution in an organic to aqueous volume ratio of 1:1 in two sequential strip stages. Separation of the phases and aqueous analysis produced the results shown in the table below.

### % Stripping of Loaded Metals from 0.125 M Pic-C₈ and 0.083M DNNSA in EXXAL 13:1-Octanol 3:2 in Two Sequential Strip Stages with 0.1 M Sulfuric Acid in a 1:1 Organic to Aqueous Volume Ratio

| | Ni | Mn | Co | Al | Zn |
|---|---|---|---|---|---|
| % Stripping | 24 | 67 | 101 | 41 | 101 |

This shows that complete cobalt stripping is achievable with dilute acid, with complete Zn co-stripping and some Ni and Mn co-stripping.

Stripping of Ni can then be achieved using more concentrated acid. For example, 90% Ni stripping was achieved in two sequential stages with 5 M sulfuric acid in an organic to aqueous ratio of 1:1.

### Example 5—Picolinamide Analogues/DNNSA

The same organic extractant system used in Example 4 but containing different picolinamide analogues was contacted with the same aqueous feed used in Example 4, in an organic to aqueous volume ratio of 1:1. The picolinamide analogues investigated are shown in FIG. 3. The pH was adjusted to approximately pH 3 by adding saturated sodium hydroxide solution. Separation and aqueous ICP-OES analysis produced the results shown in the table below.

| Pic | Extraction | % Extraction | | | | | | Extraction distribution coefficient | | | | | |
|---|---|---|---|---|---|---|---|---|---|---|---|---|---|
| analogue | pH | Li | Ni | Mn | Co | Al | Zn | Li | Ni | Mn | Co | Al | Zn |
| Pic-C8 | 3.14 | 5 | 96 | 15 | 43 | 7 | 23 | 0.06 | 22.78 | 0.17 | 0.76 | 0.08 | 0.31 |
| 4 | 3.09 | 7 | 63 | 41 | 47 | 70 | 39 | 0.08 | 1.70 | 0.71 | 0.90 | 2.35 | 0.65 |
| 5 | 3.18 | 4 | 97 | 13 | 51 | 8 | 28 | 0.04 | 29.91 | 0.15 | 1.06 | 0.08 | 0.40 |
| 6 | 3.11 | 5 | 82 | 14 | 27 | 18 | 16 | 0.05 | 4.57 | 0.17 | 0.37 | 0.23 | 0.19 |
| 7 | 3.28 | 5 | 37 | 12 | 15 | 18 | 11 | 0.05 | 0.59 | 0.14 | 0.18 | 0.21 | 0.12 |

These results show that different branched analogues show high nickel and cobalt extraction, with the exception of compound 7. Compound 5 exhibits the most similar extraction behaviour to Pic-C₈.

A sample of the loaded organic was contacted in two sequential strip stages with 0.1 M sulfuric acid, as in Example 4. The results in the table below show that high Co stripping is achieved from compounds 5 and 6, similar to Pic-C₈. High Ni stripping was also achieved for compound 7. A sample of the loaded organic for Pic-C₈ and compounds 4-6 was also stripped with 1 M sulfuric acid in two sequential contacts to remove the Ni. The results show that high Ni stripping is achieved from compounds 4 and 6, however more concentrated acid is required for compound 5.

| Pic | stripping | % Stripped | | | | | |
|---|---|---|---|---|---|---|---|
| analogue | acid | Li | Ni | Mn | Co | Al | Zn |
| pic-C8 | 0.1M | | 24 | 67 | 101 | | 101 |
| | H2SO4 | | | | | | |
| 4 | 0.1M | | 64 | 42 | 48 | 58 | 39 |
| | H2SO4 | | | | | | |
| 5 | 0.1M | | 15 | 113 | 93 | | 100 |
| | H2SO4 | | | | | | |
| 6 | 0.1M | | 50 | 84 | 99 | 96 | 96 |
| | H2SO4 | | | | | | |
| 7 | 0.1M | | 84 | 26 | 34 | 47 | 24 |
| | H2SO4 | | | | | | |

### Picolinic Acid Ester Example

The previous examples utilized picolinic acid amides (picolinamides) as the chelating extractant. However, it is also possible to utilize corresponding picolinic acid ester groups in accordance with other examples of the present invention. In this regard, it has been found that picolinic acid esters can also chelate nickel. For example, an acidic solution of ethyl 2-picolinate (0.04 M) and nickel (0.01 M) was prepared and chelation was confirmed by a colour change of the solution from green to blue colour, which is the same colour as the nickel-picolinamide complex.

The examples illustrate that organic solvent extraction compositions comprising a picolinic acid ester or amide in combination with a phase transfer catalyst (synergist) can be used to extract Ni and/or Co from typical compositions of recycling feeds for lithium ion batteries. It has also been shown that both Ni and Co can be co-extracted and then selectively stripped to yield separate Ni and Co products for re-use. When combined with known methods for separating Li and Mn, the methodology enables an efficient means to separate and recycle all four major metal element components (Ni, Co, Li, and Mn) of lithium ion battery cathode materials. The same methodology can also be applied to other recycling feeds which comprise Ni and/or Co. These include spent industrial catalysts such as Fischer-Tropsch catalyst materials.

While this invention has been particularly shown and described with reference to certain examples, it will be understood to those skilled in the art that various changes in form and detail may be made without departing from the scope of the invention as defined by the appended claims. Some further features and examples of the present specification are set out below.

### Additional Information

One methodology provides a solvent-extraction method for extracting one or more metal elements from a first composition, comprising:
(a) providing a first composition containing one or more metal elements selected from Ni and Co;
(b) contacting the first composition with a solvent extractant composition; and
(c) extracting one or more of Ni and Co from the first composition;
   wherein the solvent extractant composition comprises a picolinic acid ester or amide, such as according to the formula:

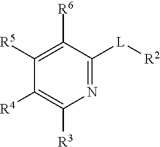

or a salt, solvate or hydrate thereof, and a synergist (phase transfer catalyst) compound, such as according to the formula:

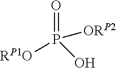

or a salt, solvate or hydrate thereof; wherein:
L is selected from —C(═O)N(R^{1A})—* and —C(═O)O—*, wherein R^{1A} is selected from hydrogen and unsubstituted straight or branched chain C₁₋₁₂ alkyl and the asterisk (*) indicates the point of attachment to R²;
R² is selected from straight or branched chain C₄₋₂₀ aliphatic groups, optionally substituted with one or two groups R^{2A};
either (i) one or two of R³, R⁴, R⁵ and R⁶ are independently selected from hydrogen and methyl, and the remaining groups of R³, R⁴, R⁵ and R⁶ are hydrogen; or (ii) the groups R³ and R⁴ and the atoms to which they are attached form an unsubstituted 6-membered aryl or an unsubstituted 6-membered heteroaryl, and each of R⁵ and R⁶ are independently selected from hydrogen and methyl;
each R^{2A} is independently selected from —OH, —SH, —NH₂, —COH and —COOH;
R^{P1} is independently selected from hydrogen and (hetero)hydrocarbyl groups; and
R^{P2} is independently selected from (hetero)hydrocarbyl groups.

L may be —C(═O)N(R^{1A})—*. Thus, the picolinic acid ester or amide according to the previous formula may be a compound according to formula:

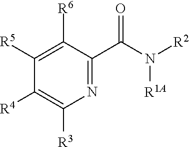

wherein R^{1A}, R², R³, R⁴, R⁵ and R⁶ are as defined above. Such compounds are particularly effective ligands for forming complexes with one or more of Ni and Co.

In some arrangements, L is —C(═O)N(R^{1A})—* and R^{1A} is one of: hydrogen; an unsubstituted straight or branched chain C₁₋₁₂ alkyl; an unsubstituted straight chain C₁₋₁₂ alkyl; an unsubstituted straight chain C₁₋₆ alkyl; a methyl. In some arrangements L is —C(═O)O—*.

In some arrangements R² is selected from one of: straight chain C₄₋₂₀ aliphatic groups, optionally substituted with one or two groups R^{2A}; unsubstituted straight chain C₄₋₂₀ aliphatic groups; straight chain C₄₋₁₈ aliphatic groups, optionally substituted with one or two groups R^{2A}; straight chain C₄₋₁₂ aliphatic groups, optionally substituted with one or two groups R^{2A}; straight chain C₄₋₁₀ aliphatic groups, optionally substituted with one or two groups R^{2A}; branched chain C₄₋₂₀ aliphatic groups, optionally substituted with one or two groups R^{2A}; unsubstituted branched chain C₄₋₂₀ aliphatic groups; branched chain C₄₋₁₈ aliphatic groups, optionally substituted with one or two groups R^{2A}; branched chain C₄₋₁₂ aliphatic groups, optionally substituted with one or two groups R^{2A}; branched chain C₄₋₁₀ aliphatic groups, optionally substituted with one or two groups R^{2A}; straight or branched chain C₆₋₁₀ alkyl groups, optionally substituted with one or two groups R^{2A}; straight chain C₆₋₁₀ alkyl groups, optionally substituted with one or two groups R^{2A}; straight chain C₆₋₁₀ alkyl groups, optionally substituted with one group R^{2A}; straight chain unsubstituted C₆₋₁₀ alkyl groups; straight chain unsubstituted C₈₋₁₀ alkyl groups; unsubstituted n-octyl.

In some arrangements one or two of R³, R⁴, R⁵ and R⁶ are independently selected from hydrogen and methyl, and the remaining groups of R³, R⁴, R⁵ and R⁶ are hydrogen. In some arrangements one of R³, R⁴, R⁵ and R⁶ is independently selected from hydrogen and methyl, and the remaining groups of R³, R⁴, R⁵ and R⁶ are hydrogen. In some arrangements each of R³, R⁴, R⁵ and R⁶ are hydrogen.

In some arrangements the groups R³ and R⁴ and the atoms to which they are attached form an unsubstituted 6-membered aryl or an unsubstituted 6-membered heteroaryl, and each of R⁵ and R⁶ are independently selected from hydrogen and methyl. In some arrangements the groups R³ and R⁴ and the atoms to which they are attached form an unsubstituted 6-membered aryl, and each of R⁵ and R⁶ are independently selected from hydrogen and methyl. In some arrangements the groups R³ and R⁴ and the atoms to which they are attached form an unsubstituted 6-membered aryl or an unsubstituted 6-membered heteroaryl, and each of R⁵ and R⁶ hydrogen. In some arrangements the groups R³ and R⁴ and the atoms to which they are attached form an unsubstituted 6-membered aryl, and each of R⁵ and R⁶ are hydrogen.

In some arrangements R^{2A} is independently selected from —OH, —NH₂, —COH and —COOH. In some arrangements R^{2A} is independently selected from —OH and —NH₂. In some arrangements R^{2A} is —OH.

In some arrangements the picolinamide extractant compound is the following compound:

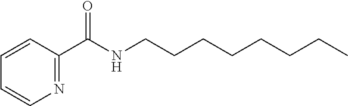 [SMILES: CCCCCCCCNC(=O)c1ccccn1]

The synergist or phase transfer catalyst compound also present in the solvent extractant composition, may be a phosphate monoester or phosphate diester, i.e. an ester of phosphoric acid which retains one or two of the original hydroxy groups of phosphoric acid.

In some arrangements R^{P1} is independently selected from hydrogen and hydrocarbyl groups; and R^{P2} is independently selected from hydrocarbyl groups. In some arrangements R^{P1} is independently selected from hydrogen and straight or branched chain aliphatic groups; and R^{P2} is independently selected from straight or branched chain aliphatic groups. In some arrangements R^{P1} is independently selected from hydrogen and straight or branched chain C₁₋₂₀ aliphatic groups; and R^{P2} is independently selected from straight or branched chain C₁₋₂₀ aliphatic groups. In some arrangements R^{P1} is independently selected from hydrogen and straight or branched chain C₁₋₂₀ alkyl groups; and R^{P2} is independently selected from straight or branched chain C₁₋₂₀ alkyl groups. In some arrangements R^{P1} is independently selected from hydrogen and straight or branched chain unsubstituted C₁₋₂₀ aliphatic groups; and R^{P2} is independently selected from straight or branched chain unsubstituted C₁₋₂₀ aliphatic groups. In some arrangements R^{P1} is independently selected from hydrogen and straight or branched chain unsubstituted C₁₋₂₀ alkyl groups; and R^{P2} is independently selected from straight or branched chain unsubstituted C₁₋₂₀ alkyl groups.

The synergist compound may be selected from one or more of an alkyl dihydrogen phosphate or a dialkyl hydrogen phosphate. In some arrangements the synergist compound is selected from one or more of a C₄₋₁₂ alkyl dihydrogen phosphate or a C₄₋₁₂ dialkyl hydrogen phosphate. The synergist compound may be a compound according to formula:

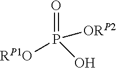

wherein R^{P1} is independently selected from hydrogen and straight or branched chain unsubstituted C₄₋₁₂ aliphatic groups; and
R^{P2} is independently selected from straight or branched chain unsubstituted C₄₋₁₂ aliphatic groups.

In some arrangements R^{P1} is independently selected from straight or branched chain unsubstituted C₄₋₁₂ aliphatic groups. In some arrangements R^{P1} is independently selected from hydrogen and straight or branched chain unsubstituted C₄₋₁₂ alkyl groups. In some arrangements R^{P1} is independently selected from hydrogen and branched chain unsubstituted C₆₋₁₂ alkyl groups. In some arrangements R^{P1} is independently selected from hydrogen and branched chain unsubstituted C₆₋₁₀ alkyl groups. In some arrangements R^{P1} is independently selected from straight or branched chain unsubstituted C₄₋₁₂ alkyl groups. In some arrangements R^{P1} is independently selected from branched chain unsubstituted C₆₋₁₂ alkyl groups. In some arrangements R^{P1} is independently selected from branched chain unsubstituted C₆₋₁₀ alkyl groups. In some arrangements R^{P1} is hydrogen.

In some arrangements R^{P2} is independently selected from: straight or branched chain unsubstituted C₄₋₁₂ alkyl groups; branched chain unsubstituted C₆₋₁₂ alkyl groups; or branched chain unsubstituted C₆₋₁₀ alkyl groups.

In some arrangements R^{P1} and R^{P2} are each independently selected from: straight or branched chain unsubstituted C₄₋₁₂ alkyl groups; branched chain unsubstituted C₆₋₁₂ alkyl groups; branched chain unsubstituted C₆₋₁₀ alkyl groups; straight or branched chain unsubstituted C₈ alkyl groups.

The synergist compound may comprise or consist of one or more of di-(2-ethylhexyl) phosphoric acid (D2EHPA) and (2-ethylhexyl)phosphoric acid (MEHPA).

Without wishing to be bound by theory, it is believed that the synergist or phase-transfer catalyst is deprotonated forming a counter-ion to the metal-ligand complex, assisting in transporting the complex from the aqueous phase into the organic phase to extract the metal. In this way, the presence of the synergist compound improves the yield of extracted metal and increases the rate at which metal may be extracted from the solution.

In some arrangements the solvent extractant composition may comprise the synergist compound in an amount of from 2 to 10 vol % based on the total volume of the solvent extractant composition, for example from 2 to 8 vol %, from 3 to 8 vol %, from 3 to 7 vol %, or about 5 vol %.

The solution of metal species to be processed is an aqueous solution and the solvent extractant composition is immiscible in the aqueous solution. In this context, the term “immiscible” indicates that the aqueous solution and the solvent extractant composition are insoluble in one another and form two distinct phases. In some arrangements, when mixed the aqueous solution and the solvent extractant composition form a multiphasic liquid (e.g. biphasic liquid) comprising an interface between the phases.

The aqueous solution in the method comprises one or more metal elements selected from Ni and Co. In some arrangements the aqueous solution comprises dissolved Ni²⁺ and dissolved Co²⁺. In some arrangements the aqueous solution is a solution of a nickel salt selected from chloride, sulfate and acetate; and a cobalt salt selected from chloride, sulfate and acetate. The concentration of Ni and Co in the aqueous solution will depend on the source of the composition. In some arrangements, the concentration of Ni and Co may be from 0.1 to 2 M, for example, 0.8 M Ni and 0.2 M Co.

In some arrangements the composition to be processed comprises an effluent solution from a battery material recycling process. Such an effluent solution may be generated, for example, by subjecting so-called “black mass” (e.g. cathode black mass or anode black mass) to a leaching/dissolving process to provide a solution containing various dissolved metal species and impurities. For example, the process may comprise dissolving the black mass in sulfuric acid/hydrogen peroxide to form Ni²⁺ and Co²⁺ sulfate salts in an acidic pH (e.g. pH 0-4)

Thus in some arrangements the method comprises processing waste battery material to generate an effluent stream comprising one or more of Ni and Co and optionally one or more additional metals selected from metals which are not Ni or Co. In some arrangements the method comprises processing waste battery material to generate an effluent stream comprising one or more of Ni and Co and optionally one or more additional metals selected from Mn, Li, Al, Zn, Na, Mg and Zr. In some arrangements, processing the waste battery material comprises generating one or more of cathode black mass and anode black mass. In some arrangements, processing the waste battery material comprises leaching one or more metals from the waste battery material. In some arrangements the method comprises processing a battery material by shredding and refining to produce black mass, and treating the black mass to generate a solution comprising one or more metal elements selected from Ni and Co.

More generally, in some arrangements the solution to be processed comprises one or more metal elements selected from Ni and Co and further comprises one or more additional metal elements selected from metals which are not Ni or Co. In some arrangements the one or more additional metal elements comprise one or more of Mn, Li, Al, Zn, Na, Mg and Zr. The method offers a means to preferentially extract one or both of Ni and Co from a composition containing one or both of Ni and Co in combination with one or more additional metal elements. The metal solution may have a pH from about 1 to about 6.

The method comprises contacting the metal solution to be processed with the solvent extractant composition. In some arrangements, this comprises mixing the two compositions, for example by adding the metal solution to the solvent extractant composition, or vice versa. After this addition the mixture may be subjected to stirring or agitation to facilitate phase-transfer of the metal elements from the aqueous phase into the organic phase. The stirring or agitation may be achieved by an overhead stirrer fitted with either a paddle or a propeller stirrer in a stirring tank. The mixture may be stirred for 15 minutes or until the pH is adjusted to the desired value. Then, the phases are separated and filtered.

The method comprises extracting one or more of Ni and Co from the solution to be processed. Such extraction of one or more of Ni and Co occurs when the solution is contacted with the organic extractant composition, due to the phase transfer effected by the picolinic acid ester or amide ligand compound which forms a complex with the metal element. The extraction step may comprise the formation of a coordination complex between the ligand compound and the metal element selected from Ni and Co. The extraction step may comprise phase-transfer of the coordination complex from the aqueous phase into the organic phase. Thus, the “extract” (organic phase) may comprise a coordination complex comprising a ligand complexed with a metal element selected from Ni and Co. The “raffinate” (aqueous phase) may comprise a concentration of one or more of Ni and Co which is depleted relative to the concentration in the starting composition.

In some arrangements the method comprises stripping one or more of Ni and Co from the organic solvent extractant composition into an aqueous solution of acid. In other words, one or more of the recovered Ni and Co may be separated from the organic solvent extractant composition by elution with acid. The organic extract may be contacted with a H₂SO₄ solution of, for example, 0.1-5 M concentration, and stirred in a stirred tank for 5-10 minutes allowing the protons to breaking down the complex formed between the ligand and metal element selected from Ni and Co. In some arrangements the method further comprises performing an electrowinning process on the resultant aqueous metal solution after stripping to recover one or more of the metal elements.

The method may be conducted under a reducing atmosphere. Without wishing to be bound by theory, it is believed that the yield of extraction of Ni and Co from the solution to be processed is maximised when the metals are in the lower +2 oxidation state in solution. Oxidation of the metals to higher oxidation states may lead to a reduced extraction yield and therefore performing the method under a reducing atmosphere may provide an improved method with a higher yield of extracted metal elements.

Picolinic acid ester or amide compounds according to this specification may have the formula:

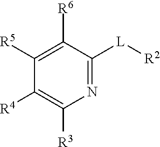

or a salt, solvate or hydrate thereof, wherein:
L is selected from —C(═O)N(R^{1A})—* and —C(═O)O—*, wherein R^{1A} is selected from hydrogen and unsubstituted straight or branched chain C₁₋₄ alkyl and the asterisk (*) indicates the point of attachment to R²;
R² is selected from straight chain C₄₋₁₀ aliphatic groups, optionally substituted with one or two groups R^{2A};
either (i) one or two of R³, R⁴, R⁵ and R⁶ are independently selected from hydrogen and methyl, and the remaining groups of R³, R⁴, R⁵ and R⁶ are hydrogen; or (ii) the groups R³ and R⁴ and the atoms to which they are attached form an unsubstituted 6-membered aryl or an unsubstituted 6-membered heteroaryl, and each of R⁵ and R⁶ are independently selected from hydrogen and methyl; and
each R^{2A} is independently selected from —OH, —SH, —NH₂, —COH and —COOH.

All of the previously discussed preferences for substituents of the picolinic acid esters and amides set out previously apply equally to the compounds of this formula.

Solvent extractant composition according to this specification comprise a picolinic acid ester or amide as described herein, a synergist or phase transfer catalyst as described herein, and an organic solvent as described herein. According to this specification the solvent extraction composition is used in a recycling process, e.g. a battery material recycling process.

Also provided is a method of manufacturing a compound according to formula:

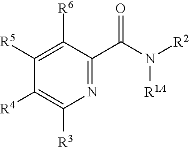

or a salt, solvate or hydrate thereof; the method comprising reacting a compound according to formula (A), or a salt, solvate or hydrate thereof, or a compound according to formula (B), or a salt, solvate or hydrate thereof:

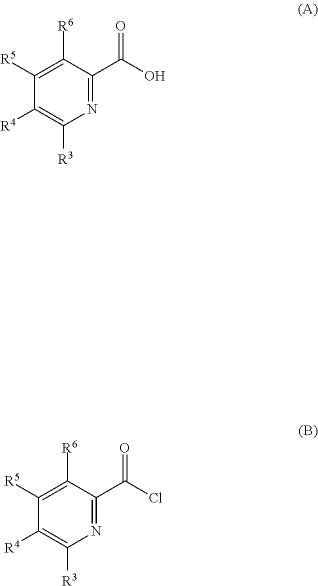

with a compound according to formula (C), or a salt, solvate or hydrate thereof:

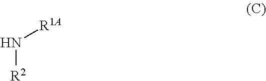

wherein the reaction of the compound of formula (A) or (B), or a salt, solvate or hydrate thereof, with the compound of formula (C) my be performed in the presence of an amide coupling reagent;
wherein:
R^{1A} is selected from hydrogen and unsubstituted straight or branched chain C₁₋₄ alkyl;
R² is selected from straight chain C₄₋₁₀ aliphatic groups, optionally substituted with one or two groups R^{2A};
either (i) one or two of R³, R⁴, R⁵ and R⁶ are independently selected from hydrogen and methyl, and the remaining groups of R³, R⁴, R⁵ and R⁶ are hydrogen; or (ii) the groups R³ and R⁴ and the atoms to which they are attached form an unsubstituted 6-membered aryl or an unsubstituted 6-membered heteroaryl, and each of R⁵ and R⁶ are independently selected from hydrogen and methyl; and
each R^{2A} is independently selected from —OH, —SH, —NH₂, —COH and —COOH.

Preferences for the substituents have been described previously in this specification and apply equally to the manufacturing method defined above.

A large number of experiments have been performed in order to support this specification. Several experiments have been described earlier in the specification. A few additional experiments are summarized briefly below.

### Additional Example 1

The n-octyl picolinamide (100 mg) was dissolved in methanol (3-4 mL) and nickel sulfate (50 mg) was added. The solution turned a strong blue colour, indicating that an octahedral complex of the n-octyl picolinamide with Ni had formed.

### Additional Example 2

The n-octyl picolinamide was dissolved in methanol and cobalt sulfate was added. The solution turned a strong pink colour, indicating that an octahedral complex of the n-octyl picolinamide with Ni had formed.

### Additional Example 3

The n-octyl picolinamide was dissolved in Shellsol D70 with 5% D2EHPA. This composition was contacted with an aqueous solution of nickel sulfate at pH 2. The organic phase turned blue, indicating extraction of Ni into the organic phase forming an octahedral complex of the n-octyl picolinamide with Ni.

### Additional Example 4

The n-octyl picolinamide was dissolved in Shellsol D70 with 5% D2EHPA. This composition was contacted with an aqueous solution of cobalt sulfate at pH 4. The organic phase turned pink, indicating extraction of Co into the organic phase forming an octahedral complex of the n-octyl picolinamide with Co.

### Comparative Example 1 (No Picolinic Acid Amide/Ester)

Di-(2-ethylhexyl) phosphoric acid (D2EHPA) was dissolved in Shellsol D70. The resultant organic solution was contacted with an aqueous phase containing nickel sulfate at pH 2. No colour change was observed indicating no extraction of Ni into the organic phase.

### Comparative Example 2 (No Synergist/Phase Transfer Catalyst)

The n-octyl picolinamide was dissolved in Shellsol D70 with 5% tributylphosphate (TBP). This composition was contacted with an aqueous solution of nickel sulfate at pH 2. No colour change was observed, indicating no extraction of nickel into the organic phase.

### Comparative Example 3 (No Synergist/Phase Transfer Catalyst)

The n-octyl picolinamide was dissolved in Shellsol D70 with 5% TBP. This composition was contacted with an aqueous solution of cobalt sulfate at pH 4. No colour change was observed, indicating no extraction of cobalt into the organic phase.

1. A method of recycling Ni and/or Co from a functional material comprising Ni and/or Co, the method comprising:
forming an acidic aqueous recycling feed of the functional material by acid leaching the functional material or a derivative thereof, the acidic aqueous recycling feed comprising Ni and/or Co in solution;
contacting the acidic aqueous recycling feed with an organic solvent extraction composition; and
extracting one or both of Ni and Co from the acidic aqueous recycling feed into the organic solvent extraction composition,
wherein the organic solvent extraction composition comprises:
(a) an organic solvent which is immiscible with the acidic aqueous recycling feed;
(b) a picolinic acid ester or picolinic acid amide which is soluble in the organic solvent; and
(c) a phase transfer catalyst.

2. A method according to claim 1,
wherein the function material is a battery material, optionally a battery cathode material, or
wherein the functional material is a catalyst material, optionally a Fischer-Tropsch catalyst material.

3. A method according to claim 1 or 2,
wherein the functional material comprises both Ni and Co,
wherein both the Ni and Co are dissolved in the acidic aqueous recycling feed,
wherein both Ni and Co are extracted into the organic solvent extraction composition, and
wherein the method further comprises selectively stripping the Ni and Co from the organic solvent extraction composition to produce two separate aqueous solutions, one comprising Ni and one comprising Co.

4. A method according to claim 3,
wherein the selective stripping comprises: (i) contacting the organic solvent extraction composition with a first acidic solution to extract Co from the organic solvent extraction composition; and then (ii) contacting the organic solvent extraction composition with a second acidic solution to extract Ni from the organic solvent extraction composition, the second acidic solution having a lower pH than the first acidic solution.

5. A method according to any preceding claim,
wherein the functional material further comprises Mn,
wherein the Mn is dissolved in the acidic aqueous recycling feed along with the Ni and/or Co, and
wherein the Mn is either removed from acidic aqueous recycling feed prior to contacting with the organic solvent extraction composition or the Mn remains in the acidic aqueous recycling feed when the Ni and/or Co are extracted from the acidic aqueous recycling feed into the organic solvent extraction composition.

6. A method according to any preceding claim,
wherein the functional material further comprises Li.

7. A method according to claim 6,
wherein the Li is extracted from the functional material or a derivative thereof prior to extracting the Ni and/or Co.

8. A method according to claim 7,
wherein the Li is extracted by dissolution in an organic acid, optionally formic acid, in which Li is soluble while Ni, Co, and Mn are insoluble.

9. A method according to any preceding claim,
wherein Cu and/or Fe is also dissolved into the acidic aqueous recycling feed by the acid leaching and the acidic aqueous recycling feed is subjected to one or more extraction steps to remove the Cu and/or Fe prior to contacting the acidic aqueous recycling feed with the organic solvent extraction composition.

10. A method according to any preceding claim,
wherein the picolinic acid ester or picolinic acid amide is defined by the following formula: 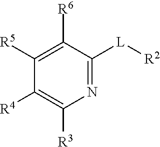
or a salt, solvate or hydrate thereof, wherein:
L is selected from —C(═O)N(R^{1A})—* and —C(═O)O—*, wherein R^{1A} is selected from hydrogen and unsubstituted straight or branched chain C₁₋₁₂ alkyl and the asterisk (*) indicates the point of attachment to R²;
R² is selected from straight or branched chain C₄₋₂₀ aliphatic groups; and
either (i) one or two of R³, R⁴, R⁵ and R⁶ are independently selected from hydrogen and methyl, and the remaining groups of R³, R⁴, R⁵ and R⁶ are hydrogen; or (ii) the groups R³ and R⁴ and the atoms to which they are attached form an unsubstituted 6-membered aryl or an unsubstituted 6-membered heteroaryl, and each of R⁵ and R⁶ are independently selected from hydrogen and methyl.

11. A method according to claim 10, wherein one or more of the following criteria are met:
wherein L is —C(═O)N(R^{1A})—*;
wherein R^{1A} is hydrogen;
wherein R² is selected from straight or branched chain C₆₋₁₀ alkyl groups, optionally substituted with one or two groups R^{2A};
wherein R² is selected from straight chain unsubstituted C₆₋₁₀ alkyl groups;
wherein R² is unsubstituted n-octyl;
wherein each of R³, R⁴, R⁵ and R⁶ are hydrogen.

12. A method according to any preceding claim,
wherein the phase transfer catalyst is a phosphoric acid or a sulfonic acid.

13. A method according to any preceding claim,
wherein the phase transfer catalyst is defined by the following formula: 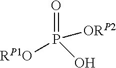
or a salt, solvate or hydrate thereof, wherein:
R^{P1} is independently selected from hydrogen and (hetero)hydrocarbyl groups; and
R^{P2} is independently selected from (hetero)hydrocarbyl groups, or
wherein the phase transfer catalyst is defined by the formula: 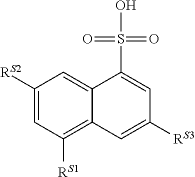
where R^{S1} is a sulfonic group (SO₃H) or a hydrogen (H), and R^{S2} and R^{S3} are either both alkyl chains or one is an alkyl chain and the other is a hydrogen.

14. A method according to claim 13,
wherein R^{P1} and R^{P2} are each independently selected from straight or branched chain unsubstituted C₄₋₁₂ alkyl groups, or
wherein R^{S1} is H, and R^{S2} and R^{S3} are both CH₂(CH₂)₇CH₃.

15. A method according to any preceding claim,
wherein the organic solvent comprises or consists of a C₈₋₁₆ hydrocarbon.

16. A method according to any preceding claim,
wherein the organic solvent is selected from one or more or an aromatic hydrocarbon, a straight chain aliphatic hydrocarbon, a branched chain aliphatic hydrocarbon, and an alcohol, preferably comprising a branched chain alcohol.
